(19) United States
(12) Patent Application Publication
(10) Pub. No.: US 2026/0104711 A1
(43) Pub. Date: Apr. 16, 2026

(54) INFORMATION PROCESSING METHOD, INFORMATION PROCESSING DEVICE, INFORMATION PROCESSING PROGRAM PRODUCT, AND STORAGE MEDIUM

(71) Applicant: DENSO CORPORATION, Kariya-city (JP)

(72) Inventor: Isao OKAWA, Kariya-city (JP)

(21) Appl. No.: 19/419,986

(22) Filed: Dec. 15, 2025

Related U.S. Application Data
(63) Continuation of application No. PCT/JP2024/022020, filed on Jun. 18, 2024.

(30) Foreign Application Priority Data
Jun. 21, 2023 (JP) 2023-101822

(51) Int. Cl. G05D 1/646; G05D 1/672

(52) U.S. Cl. CPC G05D 1/646; G05D 1/672

(57) ABSTRACT

An information processing method is executed by a processor to control display related to a target route to be traced by an autonomous towing device that tows a trailer by autonomously driving a tractor. The information processing method includes: receiving input of the target route between nodes as waypoints of the autonomous towing device; and displaying a predicted travel area through which the autonomous towing device is predicted to pass, in association with the target route. The predicted travel area is correlated with a trace error of the tractor relative to the target route, and a trace error of the trailer towed by the tractor.

### CROSS REFERENCE TO RELATED APPLICATION

The present application is a continuation application of International Patent Application No. PCT/JP2024/022020 filed on Jun. 18, 2024, which designated the U.S. and claims the benefit of priority from Japanese Patent Application No. 2023-101822 filed on Jun. 21, 2023. The entire disclosures of all of the above applications are incorporated herein by reference.

### TECHNICAL FIELD

The present disclosure relates to information processing for controlling a display of route data defining a target route to be traced by an autonomous towing device.

### BACKGROUND

A route search system searches for a travel route for a towing vehicle that tows a trailer. The route search system sets plural travel routes from the current position to the destination and a route cost for each travel route.

### SUMMARY

According to an aspect of the present disclosure, an information processing method is executed by a processor to control a display related to a target route to be traced by an autonomous towing device that tows a trailer by autonomous driving of a tractor. The information processing method includes: receiving an input of the target route between nodes as pass points of the autonomous towing device; and displaying a predicted travel area where the autonomous towing device is predicted to pass, in association with the target route. The predicted travel area may be correlated with (i) a trace error of the tractor relative to the target route input between the nodes and (ii) a trace error of the trailer towed by the tractor.

### BRIEF DESCRIPTION OF DRAWINGS

FIG. 1 is a schematic diagram showing an autonomous towing device according to a first embodiment.

FIG. 2 is a block diagram showing a configuration of an entire system including an information processing device according to the first embodiment.

FIG. 3 is a schematic diagram showing an initial state of a simulated autonomous towing device.

FIG. 4 is a block diagram showing a functional configuration of the information processing device of the first embodiment.

FIG. 5 is a flowchart showing an information processing method according to the first embodiment.

FIG. 6 is a flowchart showing detailed processing of simulation in FIG. 5.

FIG. 7 is a schematic diagram illustrating a geometric relationship of an autonomous towing device during a turning.

FIG. 8 is a schematic diagram showing an outline of a simulation process.

FIG. 9 is a schematic diagram showing an example of display when a correction input is accepted.

FIG. 10 is a schematic diagram showing an example of a final display.

FIG. 11 is a flowchart showing an information processing method according to a second embodiment.

FIG. 12 is a block diagram showing a configuration of an entire system including an information processing device according to a third embodiment.

FIG. 13 is a flowchart showing an information processing method according to the third embodiment.

### DETAILED DESCRIPTION

A route search system searches for a travel route for a towing vehicle that tows a trailer. The route search system sets plural travel routes from the current position to the destination and a route cost for each travel route. As the travel route, there are a towing route along which the trailer can travel without interfering with obstacles, and an independent route along which the towing vehicle is traveling alone. The route search system sets each route cost for the towing route and the independent route. The route search system searches for a minimum-cost route using the route costs of the towing route and the independent route depending on the driving state of the towing vehicle.

Since a route is searched for from the current position, there may be a large tracking delay, relative to the target route, at the traveling position immediately after the search. Furthermore, in case where the start position for route search is a predetermined position, when the towing vehicle is made to travel along the target route, a tracking error of the towing vehicle relative to the target route occurs. In this case, a tracking error may further occur in the trailer relative to the target route due to the difference in inner wheels between the trailer and the towing vehicle. When the tracking delay and the tracking error are not taken into account, it may be difficult to check in advance the possibility of interference with surrounding objects while traveling along the target route.

The present disclosure provides an information processing method, an information processing device, an information processing program product, and a storage medium to check in advance the possibility of interference with surrounding objects.

The technical means of the present disclosure will be described below.

According to a first aspect of the present disclosure, an information processing method is executed by a processor to control a display related to a target route to be traced by an autonomous towing device that tows a trailer by autonomous driving of a tractor. The information processing method includes: receiving an input of the target route between nodes as pass points of the autonomous towing device; and displaying a predicted travel area where the autonomous towing device is predicted to pass, in association with the target route. The predicted travel area is correlated with (i) a trace error of the tractor relative to the target route input between the nodes and (ii) a trace error of the trailer towed by the tractor.

According to a second aspect of the present disclosure, an information processing device includes a processor to control a display related to a target route to be traced by an autonomous towing device that tows a trailer by autonomous driving of a tractor. The processor is configured to: receive an input of the target route between nodes as passing points of the autonomous towing device; and display a predicted travel area where the autonomous towing device is predicted to pass, in association with the target route. The predicted travel area is correlated with (i) a trace error of the tractor relative to the target route input between the nodes and (ii) a trace error of the trailer towed by the tractor.

According to a third aspect of the present disclosure, an information processing program product is stored in a storage medium to control a display related to a target route to be traced by an autonomous towing device that tows a trailer by autonomous driving of a tractor. The information processing program product includes instructions to be executed by a processor, and the instructions include: receiving an input of the target route between nodes as passing points of the autonomous towing device; and displaying a predicted travel area where the autonomous towing device is predicted to pass, in association with the target route. The predicted travel area is correlated with (i) a trace error of the tractor relative to the target route input between the nodes and (ii) a trace error of the trailer towed by the tractor.

According to a fourth aspect of the present disclosure, a storage medium stores an information processing program including instructions to be executed by a processor to control a display related to a target route to be traced by an autonomous towing device that tows a trailer by autonomous driving of a tractor. The instructions include: receiving an input of the target route between nodes as passing points of the autonomous towing device; and displaying a predicted travel area where the autonomous towing device is predicted to pass, in association with the target route. The predicted travel area is correlated with (i) a trace error of the tractor relative to the target route input between the nodes and (ii) a trace error of the trailer towed by the tractor.

According to the first to fourth aspects, the predicted travel area that correlates with the trace error of the tractor and the trace error of the trailer relative to the target route is displayed in association with the target route. Therefore, by inputting the target route in advance, the user can check the possibility of interference between the autonomous towing device and surrounding objects, taking into account the trace errors of the tractor and the trailer, by viewing the display of the predicted travel area. Therefore, it is possible to check in advance whether there is any interference with surrounding objects.

Hereinafter, embodiments of the present disclosure will be described with reference to the drawings. In the following, corresponding components in each embodiment are denoted by the same reference numerals, and redundant descriptions may be omitted. Furthermore, in cases where only a part of the configuration is described in each embodiment, the configurations of other parts previously described in other embodiments may be applied to those parts. Further, not only the combinations of the configurations explicitly shown in the description of the respective embodiments, but also the configurations of the multiple embodiments can be partially combined together even if the configurations are not explicitly shown if there is no difficulty in the combination in particular.

### First Embodiment

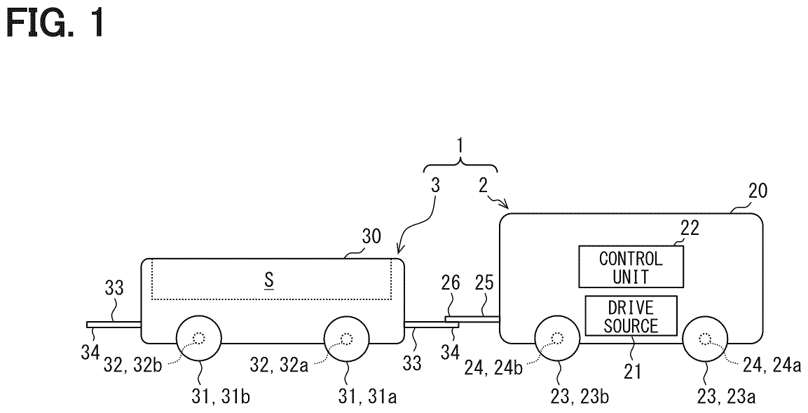

An information processing device 100 of a first embodiment controls a display related to a target route P of an autonomous towing device 1 shown in FIG. 1. The autonomous towing device 1 is an autonomous robot that can travel autonomously in any direction such as forward, backward, leftward, and rightward. The autonomous towing device 1 serving as autonomous device in the first embodiment can also be called an autonomous vehicle.

The autonomous towing device 1 includes a tractor 2 and a trailer 3. The tractor 2 has a vehicle body 20 provided with a drive source 21, a control unit 22, wheels 23, axles 24 and a connector 25. The drive source 21 is, for example, an electric motor, and the tractor 2 is a powered vehicle that is driven by the drive source.

The control unit 22 is a controller that executes autonomous driving control of the tractor 2, and is an ECU (Electronic Control Unit) including at least one dedicated computer. The control unit 22 autonomously executes acceleration/deceleration control and steering control of the tractor 2, thereby causing the tractor 2 to self-propel. The control unit 22 controls the autonomous traveling of the tractor 2 to trace the target route P in accordance with the route data relating to the target route P.

The wheel 23 includes front wheels 23a provided at the front of the vehicle body 20 and rear wheels 23b provided at the rear of the vehicle body 20. The axle 24 includes a front axle 24a having both ends at which the front wheels 23a are rotatably fixed, and a rear axle 24b having both ends at which the rear wheels 23b are rotatably fixed.

The connector 25 is provided to extend rearward from the rear end of the vehicle body 20. The connector 25 is provided with a joint 26 at the rear end, for example, to which a connector 33 of the trailer 3 is attached. The joint 26 may be, for example, a hole through which a mounting fixture such as a pin is inserted, or may be a structure formed in the shape of a hook or a hook receiver. By attaching the joint 26 to a joint 34 of the connector 33, the tractor 2 functions as a towing vehicle that tows the trailer 3 while allowing rotation around the joint 26 relative to the trailer 3.

The trailer 3 includes a vehicle body 30, wheels 31, axles 32, and the connector 33 provided on the vehicle body 30. The vehicle body 30 is provided with a loading space S for loading cargo. The loading space S is formed, for example, as a space that is open upward, and is partitioned into front, rear, left and right by parts of the vehicle body 30. The loading space S may be formed as a space that opens to the lateral side of the vehicle body 30, for example, or may simply be a space above the upper surface of the vehicle body 30 as a loading surface.

The wheel 31 include front wheels 31a and rear wheels 31b, and the axle 32 includes a front axle 32a and a rear axle 32b, similar to the tractor 2. The connector 33 is provided at each of the front end and the rear end of the vehicle body 30. Each of the connectors 33 has the joint 34 at the end opposite to the vehicle body 30, similar to the connector 25 of the tractor 2. Therefore, multiple trailers 3 can be connected to each other in the front-rear direction. The trailer 3 is, for example, a non-powered vehicle that does not have a drive source mounted thereon. The trailer 3 functions as a towed vehicle that is towed by the tractor 2.

The autonomous towing device 1 realizes autonomous driving by traveling along the predetermined target route P from a start point to a destination point. The information processing device 100 displays, to the user of the autonomous towing device 1, a message for determining the target route P in advance before the autonomous towing device 1 departs. Specifically, the information processing device 100 displays, to the user, the possibility of interference with surrounding objects for the autonomous towing device 1 tracing the target route P input by the user.

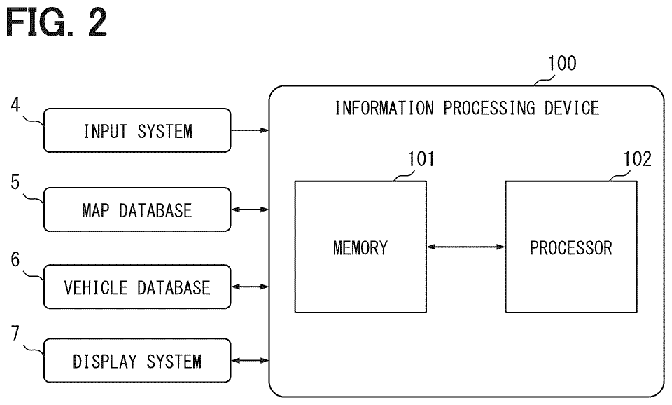

As shown in FIG. 2, the information processing device 100 is connected to an input system 4, a map database (DB) 5, a vehicle database (DB) 6, and a display system 7 via at least one of, for example, a local area network (LAN) line, a wire harness, an internal bus, and a wireless communication line.

The input system 4 accepts input operations by the user. The input system 4 is at least one of a mouse, a trackball, a keyboard, a touch panel, and the like. The input system 4 may include a device such as a microphone that accepts voice command input.

The map database 5 stores map information that can be used by the information processing device 100. The map database 5 includes at least one type of non-transitory tangible storage medium, such as a semiconductor memory, a magnetic medium, or an optical medium. The map database 5 may be a database of locator that estimates the self-state quantities including the self-position of the autonomous towing device 1. The map database 5 may be a database of a navigation unit that navigates the travel route of the autonomous towing device 1. The map database 5 may be configured by combining plural types of these databases.

The map information in the map database 5 includes at least horizontal two-dimensional position information regarding surrounding objects O that are installed in the facility area and that may become obstacles when the autonomous towing device 1 travels. For example, the map information may be point cloud data including a cloud of reflection points of the surrounding objects O acquired by an external sensor such as LiDAR (Light Detection and Ranging/Laser Imaging Detection and Ranging). In this case, each reflection point has position information. Alternatively, the map information may be image data of a group of reflection points projected onto a bird's-eye view plane. The map information may include three-dimensional position information including the height information of the surrounding object O.

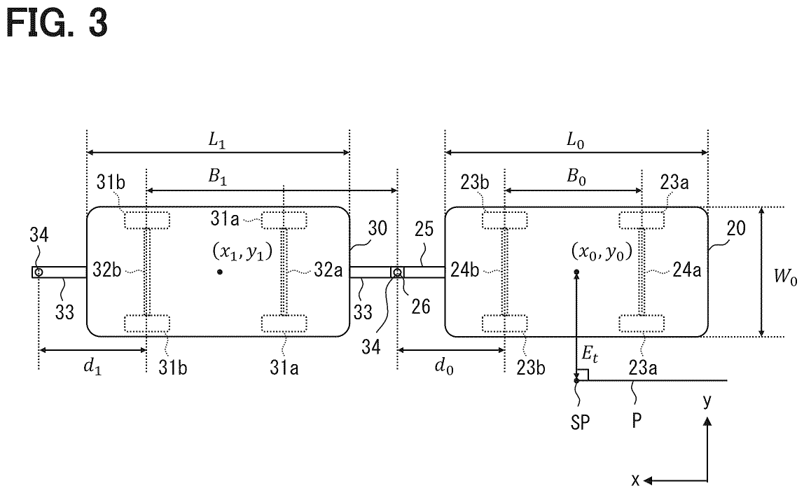

The vehicle database 6 stores information (vehicle information) related to the autonomous towing device 1 that can be used by the information processing device 100. The vehicle database 6 includes at least one type of non-transitory tangible storage medium, such as a semiconductor memory, a magnetic medium, or an optical medium. The vehicle information in the vehicle database includes information about the autonomous towing device 1 necessary for displaying a predicted travel area R (described later). For example, the vehicle information includes dimensional information for each of the tractor 2 and the trailer 3 in the autonomous towing device 1. The dimension information includes at least a base length Bᵢ, an overall vehicle body length Li, an overall vehicle body width Wᵢ, and a rear axle coupling distance dᵢ of each vehicle shown in FIG. 3. The subscript i in each parameter indicates the order from the front of the vehicle. In this embodiment, the leading tractor 2 is set to i=0.

The overall vehicle body length Li in the dimension information is the length in the front-rear direction excluding the connector 25, 33 of the vehicle body 20, 30. The overall vehicle body width Wᵢ is the length in the width direction (left-right direction) of the vehicle body 20, 30. In the case of the tractor 2, the base length Bᵢ is the so-called wheelbase length from the front axle 24a to the rear axle 24b. In the case of the trailer 3, the base length Bᵢ is the distance from the front joint 34 to the rear axle 32b, i.e., the wheelbase length plus the length from the front axle 24a to the front joint 34. The rear axle coupling distance dᵢ is the length from the rear axle 24b, 32b to the rear joint 26, 34.

The vehicle database 6 stores the dimension information in association with the identification information of the tractor 2 and the trailer 3. The identification information indicates the vehicle type of each of the tractor 2 and trailer 3, such as product name, model number, model name, etc. That is, the vehicle database 6 stores various information so that, when the vehicle type of the tractor 2 and the trailer 3 is specified, dimension information corresponding to the vehicle type can be collated.

The display system 7 displays information to the user. Specifically, the display system 7 displays the target route P and the predicted travel area R (described later) together with map information of a target area. The display system 7 is at least one type of panel, such as a liquid crystal panel or an organic EL panel.

The information processing device 100 is a computer including at least one memory 101 and one processor 102. The memory 101 is at least one type of non-transitory tangible storage medium, such as a semiconductor memory, a magnetic medium, or an optical medium, that non-temporarily stores computer-readable programs and data. Here, “storage” may refer to accumulation in which data is retained even when the computer is turned off, or may refer to temporary storage in which data is erased when the computer is turned off. The processor 102 includes at least one type of core, such as a central processing unit (CPU), a graphics processing unit (GPU), a reduced instruction set computer (RISC)-CPU, a data flow processor (DFP), and a graph streaming processor (GSP).

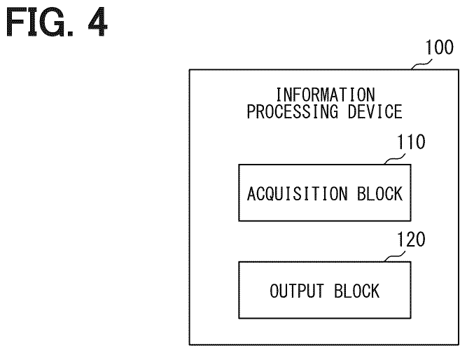

In the information processing device 100, the processor 102 executes plural instructions included in an information processing program stored in the memory 101 to control the display of route data defining the target route P to be traced by the autonomous towing device 1. As a result, the information processing device 100 constructs plural functional blocks for controlling the display of route data that defines the target route P to be traced by the autonomous towing device. The functional blocks constructed in the information processing device 100 include an acquisition block 110 and an output block 120 as shown in FIG. 4.

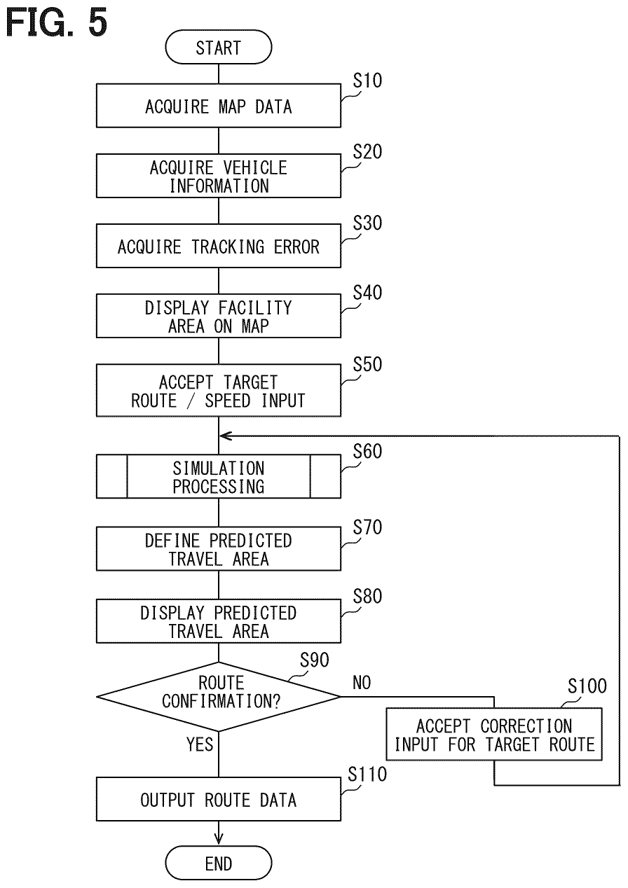

The flow of information processing method will be described below with reference to FIG. 5. The information processing device 100 controls the display of route data defining the target route P to be traced by the autonomous towing device 1 through cooperation of the acquisition block 110 and the output block 120. Hereinafter, this processing flow may be referred to as an information processing flow. This processing flow is repeatedly executed while the computer of the information processing device 100 is running. It should be noted that “S” in this processing flow represents steps executed by instructions included in the information processing program.

In S10, the acquisition block 110 acquires, from the map database 5, map information about the facility area in which the autonomous towing device 1 is to be used. In S20, the acquisition block 110 acquires vehicle information of the autonomous towing device 1. Specifically, the acquisition block 110 receives input of the user's identification information via the input system 4. The acquisition block 110 then reads out the vehicle information of the autonomous towing device 1 corresponding to the identification information from the vehicle database 6. In S30, the acquisition block 110 acquires a tracking error amount Et of the autonomous towing device 1 related to the tractor 2. The tracking error amount Et is the amount of error in the lateral direction, i.e., the normal direction relative to the target route P that is expected when the tractor 2 traces the target route P and travels autonomously. The tracking error amount Et is an example of a “trace error.” The acquisition block 110 acquires the tracking error amount Et by, for example, receiving an input of the tracking error amount Et via the input system 4. Alternatively, the acquisition block 110 may acquire the tracking error amount Et corresponding to the identification information by reading it from a storage medium such as the memory 101.

In S40, the output block 120 converts the acquired map information into an image and displays it on the display system 7 as a map of the facility area. This facility map displays at least surrounding objects O that may become obstacles when the autonomous towing device 1 travels. The facility map may further display road markings and the like. Then, in S50, the acquisition block 110 receives the target route P and the target speed V input by the user via the input system 4.

Specifically, the acquisition block 110 acquires input information about the target route P that is input so as to be superimposed on the facility map displayed on the display system 7. For example, the target route P set by a user is defined by a start point SP, an end point EP, and a path line PL. In more detail, by defining the start point SP and the end point EP on the displayed facility map by clicking the mouse or inputting coordinates, the path line PL connecting the start point SP and the end point EP is also defined on the facility map. The path line PL is displayed as an image object in vector format with at least the start point SP and the end point EP as vertices.

Therefore, the user can change the position of these vertices and the direction and magnitude of the vectors from the vertices to change the shape of the path line PL to what the user desires. The direction and magnitude of the vectors from the vertices can be changed by, for example, operating linear handles (not shown) extending from these vertices with a mouse or the like. In addition to the start point SP and the end point EP, the user may optionally add vertices that define the shape of the path line PL. The start point SP and the end point EP are examples of “nodes” that are points on the target route P that the autonomous towing device 1 passes through. The target speed V is the target traveling speed of the autonomous towing device 1 from the start point SP to the end point EP. The target speed V may be set uniformly from the start point SP to the end point EP, or may be set for each of sections obtained by further dividing the path line PL from the start point SP to the end point EP.

In S60, the output block 120 performs a simulation of the path trajectory of the autonomous towing device 1 according to the tracking error amount Et for the tractor 2 and the trailer 3 when the autonomous towing device 1 traces the input target route P. The output block 120 performs a simulation, for example, by modeling the tractor 2 and the trailer 3 in the autonomous towing device 1 using a two-wheel model. As a result, the output block 120 simulates the tracking error amount Et predicted for the trailer 3 in accordance with the tracking error amount Et of the tractor 2 given by the input.

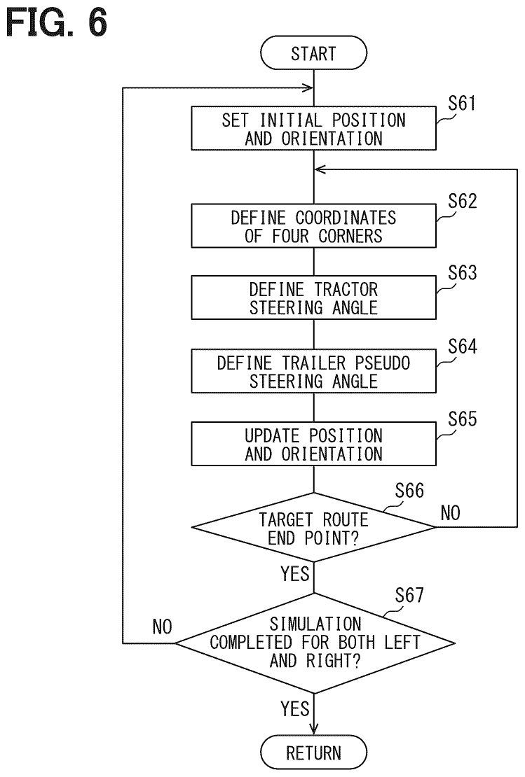

The detailed simulation process in S60 will be described with reference to the flow chart of FIG. 6. In the following, the autonomous towing device 1 in which one trailer 3 is connected to a tractor 2 will be described as an example, but simulation processing can also be performed using similar processing for an autonomous towing device 1 in which two or more trailers 3 are connected.

In S61, the output block 120 sets the initial position and initial orientation (azimuth angle) of the autonomous towing device 1. The initial position of the tractor 2 is set to a position offset from the start point SP of the target route P in the normal direction of the target route P by the tracking error amount Et of the tractor 2. The position is a representative position coordinate in the tractor 2, for example, a center position coordinate of the vehicle body 20. The coordinate system is a Cartesian coordinate system fixed relative to the road surface. As will be described later, this simulation process is executed for two sets of cases, one where the tracking error occurs to the right of the target route P and one where the tracking error occurs to the left of the target route P. Therefore, the offset direction in S61 is determined depending on whether this step is the first set or the second set. In the following description, left and right are defined when the autonomous towing device 1 moves in the direction of travel.

The initial orientation of the tractor 2 is set to an azimuth angle in the tangential direction of the start point SP. The initial position and the initial orientation of the trailer 3 are set to a position and orientation in which the joint angle of the connector 33 is zero, i.e., the trailer 3 is linearly connected to the tractor 2, with the tractor 2 set to the initial position and the initial orientation.

In S62, the output block 120 defines the position coordinates of the four corners of the vehicle body 20, 30 of the tractor 2 and the trailer 3 when viewed from above, assuming that each vehicle body 20, 30 has a substantially rectangular shape. The output block 120 may calculate the position coordinates of each of the four corners from the representative position coordinates, orientation θᵢ, overall vehicle body length Li, and overall vehicle body width W₁ of the tractor 2 and the trailer 3. The positions of the four corners of each vehicle body 20, 30 are candidate positions that can be located at the outermost left and right ends on the outer periphery of the vehicle body 20, 30 when the vehicle is running. Multiple position coordinates may be defined as candidate positions when the shape is considered to be closer to the actual shape of the vehicle body 20, 30.

In S63, the output block 120 defines the steering angle δ₀ when the tractor 2 follows the target route P while maintaining the tracking error amount Et. For example, the output block 120 defines the steering angle δ₀ when it is assumed that tracking control is performed using PID control. In this case, the steering angle δ₀ corresponds to parameters expressed by Equation 1 using proportional gain kₚ, differential gain k_{d}, integral gain kᵢ, and deviation “e” from the target route P, which is obtained by subtracting the tracking error amount Et as the target value, from the offset amount in the simulation.

$${δ}_{0} = - {k}_{p} \cdot e - {k}_{d} \cdot de / dt - {k}_{i} \cdot \int e dt \qquad Equation 1$$

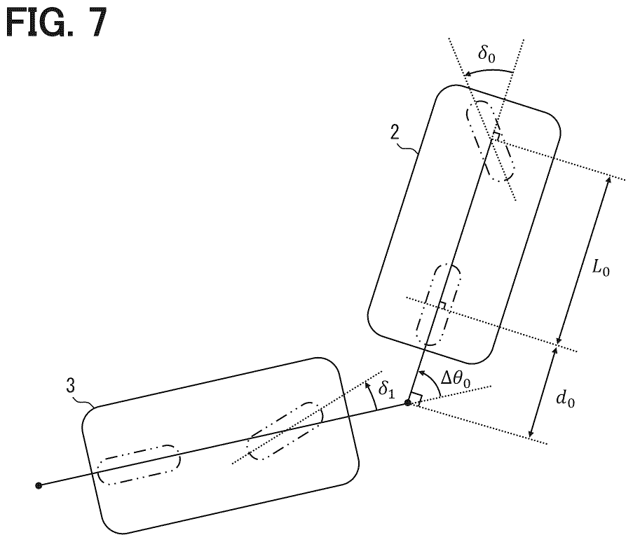

In S64, the output block 120 defines the steering angle δᵢ corresponding to the turning operation of the trailer 3. The turning movement of the trailer 3 occurs when the front wheels of the trailer 3 rotate in response to towing by the tractor 2, and the front wheels of the trailer 3 are not directly steered by steering control. Therefore, the steering angle δᵢ corresponding to the turning operation is a pseudo steering angle δᵢ generated by the towing of the tractor 2 (hereinafter referred to as trailer pseudo steering angle). The output block 120 geometrically defines the pseudo steering angle δᵢ of the i-th trailer 3 based on the base length Bᵢ₋₁, rear axle coupling distance dᵢ₋₁, joint angle Δθᵢ₋₁, etc. of the vehicle immediately preceding the trailer 3 shown in FIG. 7. In this embodiment, the preceding vehicle is the tractor 2.

In S65, the output block 120 updates the simulated positions of the tractor 2 and the trailer 3 after Δt seconds. The updated position correlates with the target speed V and the steering angle δᵢ in the simulation. Specifically, the updated positions x_{i_new} and y_{i_new} correspond to values expressed by Equation 2 and Equation 3 using the above parameters.

$${x}_{i \_ new} = {x}_{i} + V cos {θ}_{i} \cdot Δ t \qquad Equation 2$$

$${y}_{i \_ new} = {y}_{i} + V sin {θ}_{i} \cdot Δ t \qquad Equation 3$$

Furthermore, the updated orientation θ_{i_new} is correlated with the base length Bᵢ in addition to the target speed V and the steering angle δᵢ. Specifically, the updated orientation corresponds to a value expressed by Equation 4 using the above parameters.

$${θ}_{i \_ new} = {θ}_{i} + V tan \frac{{δ}_{i}}{{B}_{i}} \cdot Δ t \qquad Equation 4$$

In S66, the output block 120 determines whether the updated position of the tractor 2 has reached the end point EP of the target route P. When it is determined that the end point EP has not been reached, the flow returns to S62, where the updated positions x_{i_new}, y_{i_new} and orientation θ_{i_new} are replaced with new current positions xᵢ, yᵢ and orientation θᵢ, and a series of processes from S62 to S65 is executed.

When it is determined in S66 that the updated position of the tractor 2 has reached the end point EP, the flow proceeds to S67. In S67, the output block 120 determines whether the simulation using the series of processes from S61 to S63 has been completed for both the case where the vehicle travels to the left of the target route P while maintaining the tracking error amount Et, and the case where the vehicle travels to the right of the target route P while maintaining the tracking error amount Et. When it is determined that the simulation is incomplete, the flow returns to S61, and a simulation is executed for the case where the vehicle is traveling in the incomplete direction while maintaining the tracking error amount Et.

Returning to FIG. 5, in S70, the output block 120 defines the predicted travel area R in association with the target route P according to the results of the simulation process. Specifically, for each position on the target route P, the output block 120 searches for the nearest point in the trajectory coordinates of the coordinates of the four corners for all vehicles of the autonomous towing device 1. The output block 120 sets the time step Δt so that the interval between the trajectory coordinates is sufficiently small, so that the distance from a point on the target route P to the nearest point is an offset amount in the normal direction to the target route P.

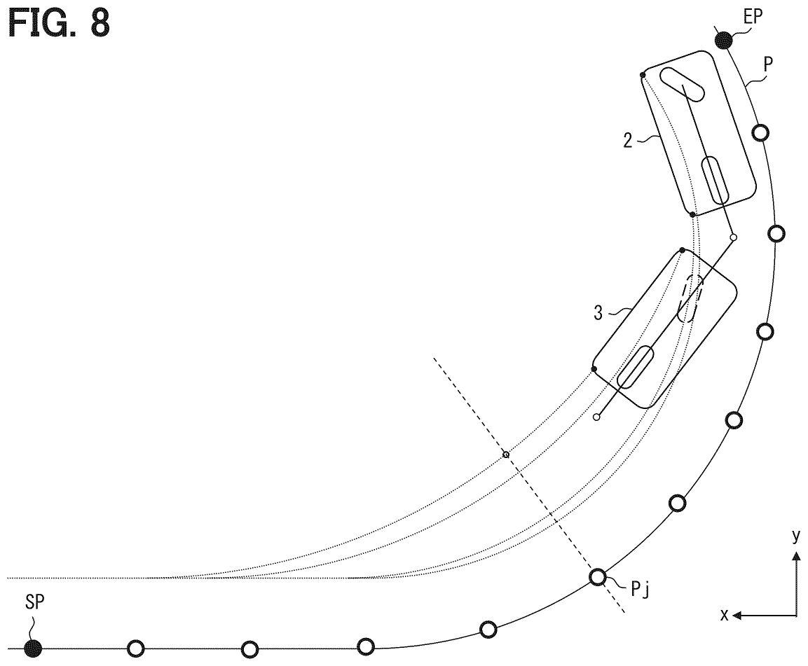

The output block 120 acquires the offset amount for each of the four corner trajectories of all the vehicles of the autonomous towing device 1. The output block 120 extracts the maximum offset amount that is the largest for each of the positions on the target route P. The output block 120 defines this maximum offset amount as the left width length of the target route P from each specific position in the predicted travel area R. In FIG. 8, for a certain position Pj in a left-curve portion of the target route P, the maximum offset amount to the trajectory of the left rear end of the trailer 3 is defined as the left width length of the predicted travel area R. The output block 120 also defines the right width of the predicted travel area R in a similar manner. As a result, the predicted travel area R is defined as a region linked to the target route P that correlates with the tracking error amount Et of the tractor 2 and the trailer 3 relative to the target route P.

In S80, the output block 120 causes the display system 7 to display the predicted travel area R simulated by the above processing. Specifically, the output block 120 reconverts the left and right width of the predicted travel area R for each point on the target route P into left and right coordinates in the normal direction, and converts them into image coordinates using pixel resolution or the like. The output block 120 generates an object that connects position coordinates on the left and right sides of the predicted travel area R, and displays it superimposed on the facility map. The position coordinates of the objects may be connected in a straight line or in a curved line. The object is, for example, a polygon that covers the target route P in a tube shape.

In S90, the acquisition block 110 determines whether the target route P has been determined. For example, when the acquisition block 110 receives an input from the user via the input system 4 to confirm the target route P, the acquisition block 110 determines that the target route P has been confirmed. When it is determined that the target route P is not established, the flow proceeds to S100.

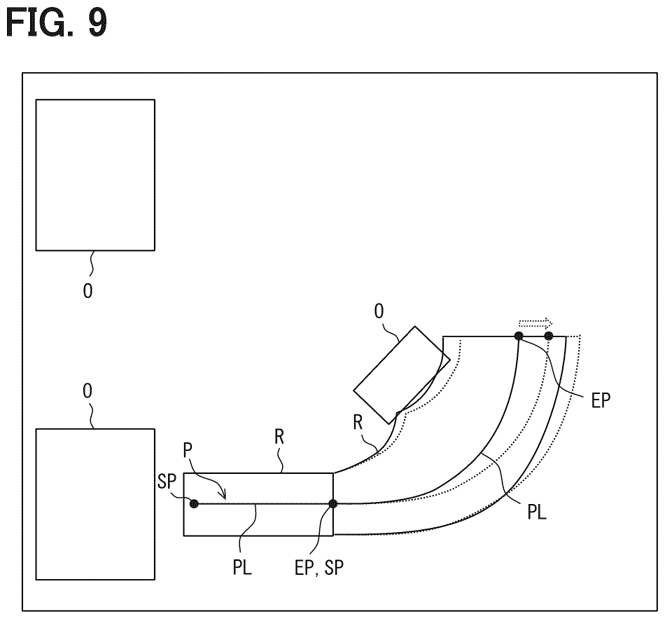

In S100, the acquisition block 110 receives a correction input for the target route P. The acquisition block 110 receives correction input by acquiring, for example, input information via the input system 4 by the user to change any of the start point, end point EP, and path line PL of the target route P on the display. In FIG. 9, the predicted travel area R interferes with a surrounding object O, so the target route P is corrected by moving the end point EP. When the correction input is received, the flow returns to S60, and a predicted travel area R for the corrected target route P is generated.

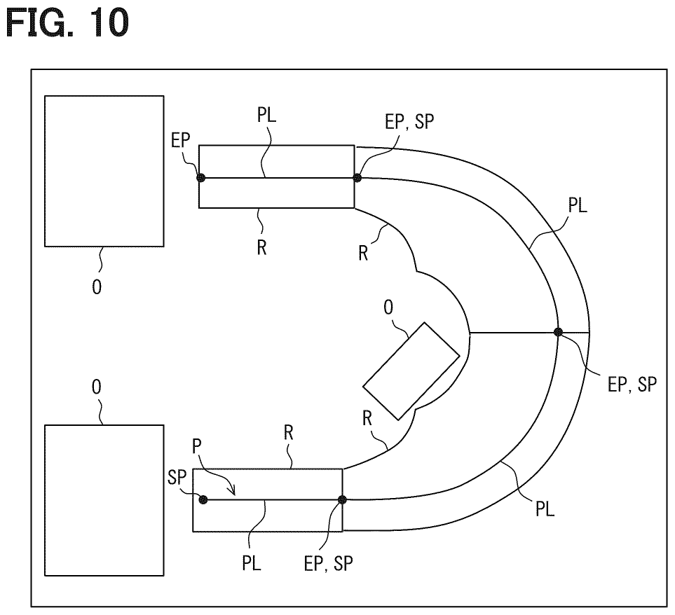

When it is determined in S90 that the target route P has been established, the flow proceeds to S110. In S110, route data relating to the determined target route P is output. The route data is output by, for example, storing it in a storage medium such as the memory 101 or an external memory, or transmitting it to the autonomous towing device 1. As shown in FIG. 10, the information processing device 100 repeats the above processing until the user sets a target route P to the final destination point of the autonomous towing device 1.

According to the first embodiment, the predicted travel area R, which correlates with the tracking error amount Et of the tractor 2 and the tracking error amount Et of the trailer 3 relative to the target route P, is displayed in association with the target route P. Therefore, by inputting the target route P in advance, the user can check the possibility of interference between the autonomous towing device 1 and surrounding objects O, taking into account the tracking error amount Et of the tractor 2 and the trailer 3, by displaying the predicted travel area R. Therefore, it may be possible to check in advance whether there is a possibility of interference with the surrounding object O.

### Second Embodiment

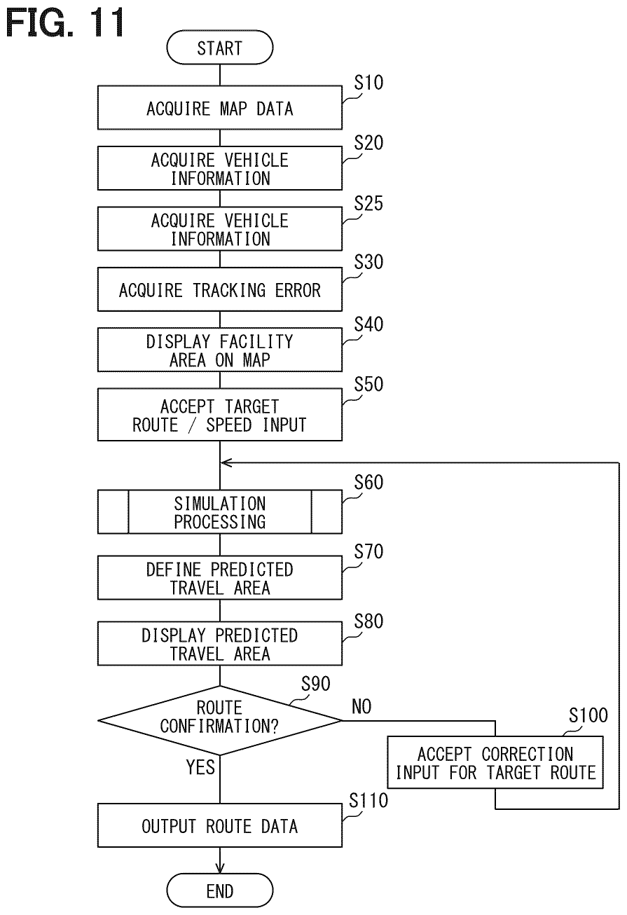

As shown in FIG. 11, the second embodiment is a modification of the first embodiment. In the second embodiment, the information processing device 100 defines and displays the predicted travel area R as a region that also correlates with the weight of the autonomous towing device 1.

In the second embodiment, the vehicle database 6 further stores the vehicle body weights Mbᵢ of the tractor 2 and the trailer 3 as vehicle information. The vehicle body weight Mbᵢ stored in the vehicle database 6 is the weight of the vehicle in an unladen state, i.e., when no cargo is loaded. The vehicle database 6 stores the vehicle body weight Mbᵢ in association with the identification information of the tractor 2 and the trailer 3.

As shown in FIG. 11, the information processing flow in the second embodiment proceeds to S25 after S20. In S25, the acquisition block 110 receives an input of the load weight Mlᵢ of the load on the trailer 3. When multiple trailers 3 are towed, the acquisition block 110 receives input of the load weight Mlᵢ for each trailer 3.

Furthermore, in the update process of S65 (see FIG. 6) in this flow, the output block 120 acquires the updated orientation θ_{i_new} as a value correlated with the vehicle body weight Mbᵢ and the load weight Mlᵢ. Specifically, the updated orientation θ_{i_new} corresponds to a value calculated by Equation 5 including the total weight Mgᵢ, which is the sum of the vehicle body weight Mbᵢ and the load weight Mlᵢ.

$${θ}_{i \_ new} = {θ}_{i} + \frac{1}{1 + A ( {M}_{i} ) \cdot {V}^{2}} \frac{V}{{B}_{i}} {δ}_{i} \cdot Δ t \qquad Equation 5$$

The function A(Mᵢ) in Equation 5 is a stability factor. The stability factor is a parameter that indicates the ease with which a vehicle can turn, and is a function of the total weight Mgᵢ, the coefficient of friction between the wheels and the road surface, and the like.

According to the second embodiment, the information processing device 100 can display a planned travel area that corresponds to changes in the travel characteristics of the autonomous towing device 1 due to weight.

### Third Embodiment

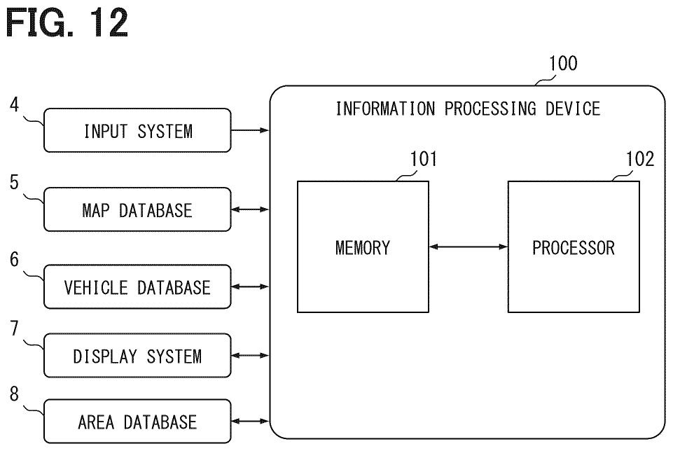

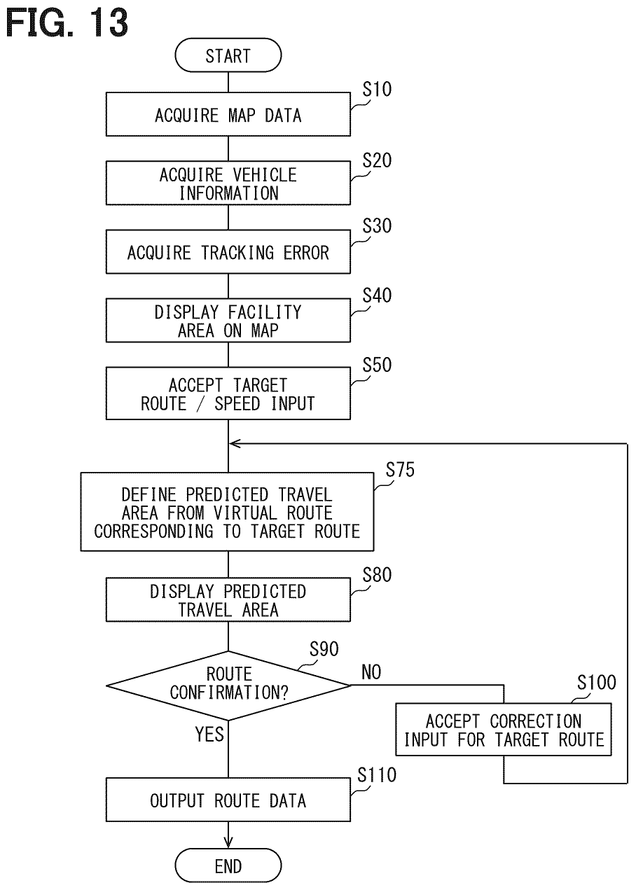

As shown in FIGS. 12 and 13, the third embodiment is a modification of the first embodiment. In the third embodiment, the information processing device 100 defines the predicted travel area R for the target route P in accordance with information obtained by simulating plural virtual routes assumed for the target route P in advance.

The area database 8 stores information relating to the predicted travel area R that can be used by the information processing device 100. The area database 8 includes at least one type of non-transient tangible storage medium, such as a semiconductor memory, a magnetic medium, or an optical medium. The area information in the area database 8 includes, for example, for each vehicle type, at least information regarding the left and right width lengths of the predicted travel area R as the result of simulations performed in advance for multiple types of virtual routes assumed as the target route P at multiple levels of the target speed V. Among the multiple types of virtual routes, the route curvature and the tracking error amount Et of the tractor 2 are changed in multiple stages.

The area information is stored in the form of a lookup table that can output the right and left widths of the predicted travel area R in response to inputs of the curvature of the target route P, the target speed V, and the tracking error amount Et. This area information is stored for each piece of identification information of the autonomous towing device 1.

In the information processing flow in the third embodiment, as shown in FIG. 13, the process proceeds to S75 after S50. In S75, the output block 120 identifies a virtual route that matches the input target route P from the area database 8, and defines the predicted travel area R by reading the left and right width lengths of the predicted travel area R corresponding to the virtual route. A virtual route that matches the target route P is identified as, for example, a virtual route whose difference in curvature from the curvature of the target route P falls within a predetermined difference range. The target route P may be further divided into sections, and a virtual route that matches each section may be identified.

### OTHER EMBODIMENT

Although multiple embodiments have been described above, the present disclosure should not be construed as being limited to those embodiments, and can be applied to various embodiments and combinations within the scope that does not deviate from the gist of the present disclosure.

In a modified example, the output block 120 may execute simulation processing of the tractor 2 and the trailer 3 using a vehicle model other than the two-wheel model.

In a modified example, at least one of the tractor 2 and the trailer 3 may have an axle independently fixed for each wheel, instead of the wheels fixed to both ends of the axle.

In a modified example, the computer constituting the information processing device 100 may have at least one of a digital circuit and an analog circuit as a processor. Here, the digital circuit refers to at least one of the following: an ASIC (Application Specific Integrated Circuit), an FPGA (Field Programmable Gate Array), an SOC (System on a Chip), a PGA (Programmable Gate Array), and a CPLD (Complex Programmable Logic Device). Such digital circuitry may also have a memory that stores a program.

In a modified example, the memory 101 storing the information processing program may be a portable storage medium that is removable from the information processing device 100. In this case, the memory 101 may be a storage medium in which an information processing program is stored so as to be readable by the information processing device 100 as a computer, and which is used to carry the program to be installed in the information processing device 100. Alternatively, the memory 101 may be a storage medium of a server device that distributes an information processing program to the information processing device 100 of the user.

In a modified example, the host mobile body to which the information processing device 100 is applied may be, for example, an autonomous traveling robot capable of transporting luggage or collecting information by autonomous traveling or remote traveling. In addition to the forms described so far, the above-mentioned embodiments and variations may be implemented in the form of a processing circuit (e.g., a processing ECU, etc.) or a semiconductor device (e.g., a semiconductor chip, etc.) as a control device configured to be mountable on a host mobile body and having at least one processor 102 and one memory 101.

What is claimed is:

1. An information processing method to be executed by a processor to control a display related to a target route to be traced by an autonomous towing device that tows a trailer by autonomous driving of a tractor, comprising:
receiving an input of the target route between nodes which are pass points of the autonomous towing device; and
displaying a predicted travel area through which the autonomous towing device is predicted to pass in association with the target route, wherein
the predicted travel area is correlated with (i) a trace error of the tractor relative to the target route input between the nodes, and (ii) a trace error of the trailer towed by the tractor.

2. The information processing method according to claim 1, wherein
the receiving includes receiving an input of a target speed between the nodes, and
the predicted travel area is correlated with the trace error of the trailer relative to passing the target route at the target speed.

3. The information processing method according to claim 1, wherein
the receiving includes receiving an input of identification information to identify the autonomous towing device, and
the predicted travel area is correlated with the trace error of the trailer in the autonomous towing device identified by the identification information, relative to the target route.

4. The information processing method according to claim 1, wherein
the displaying of the predicted travel area in association with the target route includes: simulating and displaying the predicted travel area for the target route in response to an input of the target route.

5. The information processing method according to claim 1, wherein
the displaying of the predicted travel area in association with the target route includes:
reading out area information from a database storing the area information being related to the predicted travel area simulated for a plurality of virtual routes assumed for the target route, the read-out area information corresponding to one of the virtual routes that matches the target route; and
displaying the predicted travel area in response to the read-out area information.

6. The information processing method according to claim 1, wherein
the receiving of the input of the target route further includes: receiving an input for correcting the target route displayed in association with the predicted travel area.

7. The information processing method according to claim 1, wherein
the displaying of the predicted travel area in association with the target route includes: generating route data that defines the target route.

8. The information processing method according to claim 7, wherein
the displaying of the predicted travel area in association with the target route includes: outputting the generated route data.

9. An information processing device comprising: a processor to control a display related to a target route to be traced by an autonomous towing device that tows a trailer by autonomous driving of a tractor, wherein the processor is configured to
receive an input of the target route between nodes which are pass points of the autonomous towing device; and
display a predicted travel area through which the autonomous towing device is predicted to pass in association with the target route, wherein
the predicted travel area is correlated with (i) a trace error of the tractor relative to the target route input between the nodes, and (ii) a trace error of the trailer towed by the tractor.

10. An information processing program product stored in a non-transitory storage medium to control a display related to a target route to be traced by an autonomous towing device that tows a trailer by autonomous driving of a tractor, and comprising instructions configured to, when executed by a processor, cause the information processing program product to
receive an input of the target route between nodes which are pass points of the autonomous towing device; and
display a predicted travel area through which the autonomous towing device is predicted to pass in association with the target route, wherein
the predicted travel area is correlated with (i) a trace error of the tractor relative to the target route input between the nodes, and (ii) a trace error of the trailer towed by the tractor.

11. A non-transitory storage medium storing an information processing program to control a display related to a target route to be traced by an autonomous towing device that tows a trailer by autonomous driving of a tractor, and including instructions configured to, when executed by a processor, cause the information processing program to
receive an input of the target route between nodes which are pass points of the autonomous towing device; and
display a predicted travel area through which the autonomous towing device is predicted to pass in association with the target route, wherein
the predicted travel area is correlated with (i) a trace error of the tractor relative to the target route input between the nodes, and (ii) a trace error of the trailer towed by the tractor.
